(19) United States
(12) Patent Application Publication
(10) Pub. No.: US 2013/0332950 A1
(43) Pub. Date: Dec. 12, 2013

(54) METHOD AND EQUIPMENT FOR COLLECTING AND PROCESSING INFORMATION REPRESENTING EQUIPMENT OPERATING CONDITIONS

(71) Applicants: Gilbert Landais, Servon Sur Vilaine (FR); Simon Gloanec, Rennes (FR)

(72) Inventors: Gilbert Landais, Servon Sur Vilaine (FR); Simon Gloanec, Rennes (FR)

(73) Assignee: France Telecom, Paris (FR)

(21) Appl. No.: 13/993,002

(22) PCT Filed: Dec. 5, 2011
(86) PCT No.: PCT/FR2011/052864

§ 371 Date: Aug. 16, 2013

(30) Foreign Application Priority Data
Dec. 10, 2010 (FR) 1060395

(51) Int. Cl. H04N 21/24

(52) U.S. Cl. CPC H04N 21/24
USPC 725/14

(57) ABSTRACT

The invention relates to a method for communicating information relating to operating conditions of local equipment (STB), to remote equipment. The method according to the invention comprises: a step of measuring at least one value of a primitive parameter Dsk representing said operating conditions, and a step of processing said parameter using a calculation unit (CMEM, CPU) that can execute a plurality of calculation operations. The local equipment (STB), in line with the invention, can produce a multiplicity of data signals relating to variables representing operating conditions of said equipment on the basis of values of primitive parameters Dsk, without it being necessary to pre-define and physically implement a large number of complex functions as in prior art.

### CROSS-REFERENCE TO RELATED APPLICATIONS

This Application is a Section 371 National Stage Application of International Application No. PCT/FR2011/052864, filed Dec. 5, 2011, which is incorporated by reference in its entirety and published as WO 2012/076795 on Jun. 14, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE INVENTION

The invention pertains to a method for communicating information to a remote equipment on conditions of operation of a local equipment.

Such methods are commonly used by operators of services such as telecommunications services to quantify the quality of service effectively furnished to customers subscribing to these services. The purpose of these methods especially is to enable the identification of malfunctioning in equipments installed at the customer's home or premises, as part of an on-going policy of improving the quality perceived by these customers.

Local equipments whose operating conditions are monitored by the remote equipment can be of different kinds, and can consist for example of home gateways, set-top boxes etc. and are therefore likely to come from numerous manufacturers. The remote equipments are distinct from local equipments and are connected to them either via a same local-area network or via a remote network, for example of the Internet type. In order to achieve interoperability between local equipments and remote equipments, it has turned out to be necessary to formalize protocols defining especially the nature of the information that must be generated by a local equipment for transmission to a remote equipment.

### PRIOR ART

In the prior art, each local equipment is given a very large number of predetermined computing functions. One such computation function is intended, for example, for the generation of a value representing a count of occurrences of a certain type of event per time intervals of a predetermined duration, for example a number of untimely restarts that the equipment has undergone in a twenty-day interval, or again a number of data packets lost in a ten-minute interval etc. According to another example, a computation function of this kind is intended to generate various other statistical values and/or indicators such as especially a minimum/maximum value, an average value or a crossing of a threshold by a particular parameter (temperature, voltage, current etc.).

According to the known technique, once these functions of computation have been defined and implemented in a local equipment, it is not possible in principle to consider making said local equipment carry out other computations in order to make it generate pieces of information other than those for whose production it has been configured. Thus, as a measure of precaution, the existing protocols have been designed to account almost exhaustively for all the values that can be of interest to a remote equipment, so that the number of computation functions to be implemented within local equipments is so high that it becomes prohibitive, so much so that the technique of observation of the conditions of operation of local equipments by remote equipments is not yet truly operational and is only making very slow progress towards this goal.

### SUMMARY OF THE INVENTION

Indeed, according to a functional aspect, the invention pertains to a method according to the introductory paragraph, characterized in that it includes:
a step of measuring at least one value of a primitive parameter representing said conditions of operation, and
a step of processing said parameter by means of a computation unit capable of executing a plurality of computation operations.

The computation unit gives the method of the invention great flexibility of use, since it enables the computation of any physical quantity whatsoever from the values of the primitive parameters. It is thus no longer necessary to predefine and physically implement complex functions in large numbers as in the prior art, since the computation unit can be programmed dynamically to carry out any type of computation.

The processing step can be performed both in the remote equipment and in the local equipment.

However, in applications where the local equipment and the remote equipment are connected together via a communications network of limited bandwidth, which is a very common situation, it will be advantageous to make the local equipment carry out a first-level analysis and to plan to forward information to the remote server only in cases where certain predetermined events occur.

Thus, in one advantageous mode of implementation of the invention, a communications method as described further above is characterized in that it includes a step of transmitting, to said remote equipment, a notification generated when the processing step produces a result compliant with a pre-determined criterion.

Such a predetermined criterion could consist of a maximum or minimum operating temperature, a maximum number of lost packets acceptable for a given time interval, etc.

The computation unit will comprise, in principle, an essential core of basic computation functions such as elementary mathematical and logic operations, so that this computation unit will be capable of processing numbers, strings of characters and Boolean values. Provided with this essential core, the computation unit will also be capable of performing elementary statistical computations such as determining minimum, maximum and average values, etc.

The computation unit according to the invention will advantageously be dynamically configurable by software means in order to enable the local equipment to carry out any type of computation that could produce information of interest to the remote equipment.

In such a mode of implementation, a method as described further above will include at least one step of software configuration of the computation unit by incorporation, within said plurality of computation operations, of at least one computation function having at least one primitive parameter as a variable.

The computation functions could be defined one by one but they could sometimes also be generated automatically or semi-automatically. Thus, according to one particular mode of implementation of the invention, a method as described here above will include at least one step of entering a parameter and one step of automatically breaking down said parameter into a series of predetermined functions having this parameter as a variable.

In this mode of implementation, it is enough to enter a parameter to generate a family of functions relatives to this parameter, for example a <<Min>> function giving the minimum value attained by this parameter, a <<MinTime>> giving the date and time at which this minimum value was attained, a <<Max>> function giving the minimal value attained by this parameter and a <<MaxTime>> function giving the date and the time at which this maximum value has been attained. Thus, on the basis of a single primitive parameter, four values representing conditions of operation of the local equipment will be automatically generated.

According to a hardware aspect, the invention also pertains to a local equipment capable of communicating information, to a remote equipment, on operating conditions of said local equipment, characterized in that it includes:
means for measuring at least one value of a primitive parameter representing said conditions of operation, and
means for processing said parameter comprising a computation unit capable of executing a plurality of operations of computation.

According to another hardware aspect, the invention also pertains to a communications system including at least one local equipment according to the above description and a remote server intended for the receiving of information on the conditions of operation of said local equipment.

According to another hardware aspect, the invention also pertains to a computer program characterized in that it comprises program code instructions for implementing a method according to claim 1 when this program is executed by a processor.

### LIST OF FIGURES

Other features and advantages of the invention shall appear more clearly from the following description of a particular embodiment, given by way of a simple illustratory and non-exhaustive example and from the appended drawings, of which:

FIG. 1 is a functional diagram that represents a system of communications in which the invention is implemented;

FIG. 2 is a functional diagram that represents an alternative embodiment of a communications system such as this, and

FIG. 3 is a functional diagram that represents a equipment according to the invention.

### DESCRIPTION OF ONE EMBODIMENT OF THE INVENTION

### 1. General Principle

The general principle of the invention relies on an integration, within a equipment, of a computer program capable of performing elementary mathematical, statistical and logic operations in order to produce a multiplicity of physical quantities representing conditions of operation of said equipment from values of primitive parameters without its being necessary to predefine and physically implement complex functions in large numbers as in the prior art.

### 2. Description of a Mode of Implementation

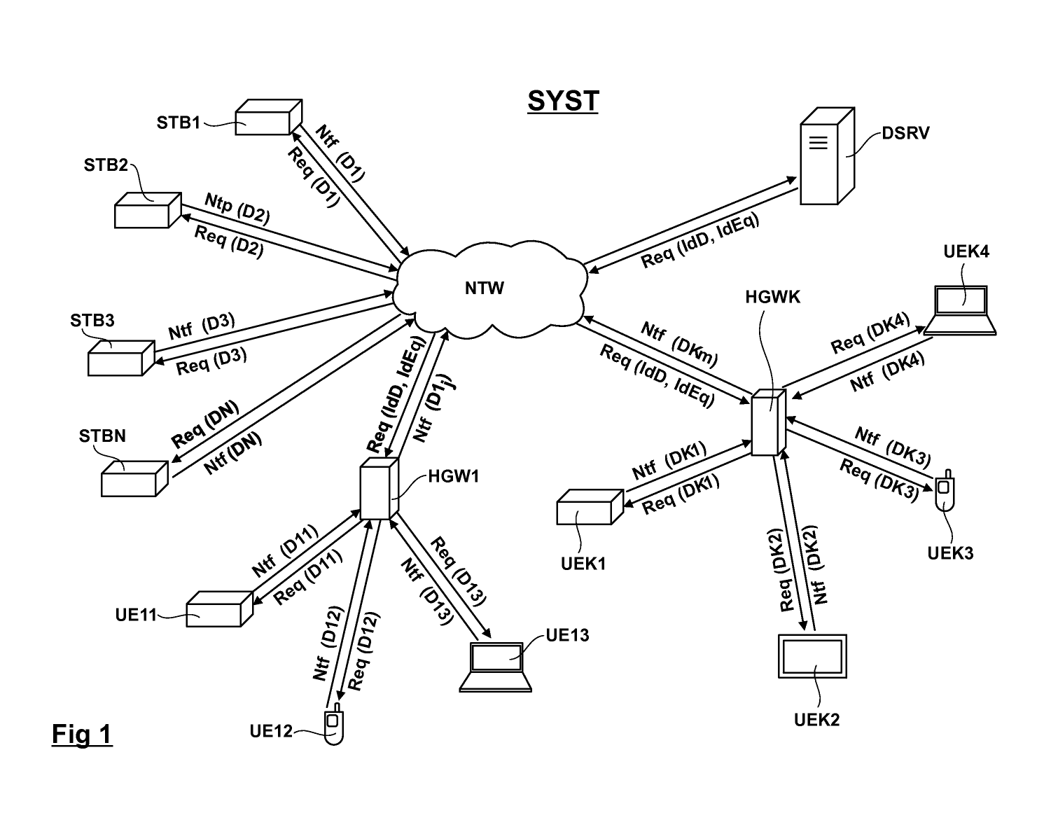

FIG. 1 illustrates a mode of implementing the invention within a telecommunications system SYST, that includes N equipments called local equipments STB1, STB2, STB3 . . . STBN connected to a remote equipment DSRV via a communications network NTW, for example a network compliant with the Internet protocol. The local equipments STBi (for i=1 to N) are, in this example, television digital signal decoders or set-top boxes installed in the homes of subscribers to an audiovisual program broadcasting service while the remote equipment DSRV is a server for tracking the quality of service perceived by said subscribers. To this end, each local equipment includes in this example:
means for measuring at least one value of a primitive parameter Di (for i=1 to N) representing said conditions of operation, and
means for processing said parameter Di (for i=1 to N) comprising a computation unit capable of executing a plurality of computation operations.

In the example shown here, each of the local equipments STBi (for i=1 to N) performs a first-level analysis, and forwards information to the remote equipment DSRV only in cases when a predetermined event has occurred. This prevents an unnecessarily high consumption of bandwidth which would be entailed by a systematic dispatching, by each local equipment STBi (for 1=1 to N), of the values taken by the primitive parameter or parameters whose progress it must report to the remote equipment DSRV.

Thus, a local equipment STBi (for i=1 to N) will send said the remote equipment DSRV a notification Ntf(Di) which will be generated when the step of processing the primitive parameter Di produces a result compliant with a predetermined criterion.

Such a predetermined criterion could consist of a maximum or minimum temperature of operation if the parameter Di represents the temperature of operation of the local equipment STBi (for i=1 to N), or again a maximum number of lost packets acceptable for a given time interval if the parameter Di represents a number of packets accounted for as being lost by the local equipment STBi (for i=1 to N), etc. Although this is not shown explicitly in the present figure so as not to unnecessarily complicate the understanding of it, each local equipment will, in principle, carry out a measurement and a processing of a multiplicity of parameters and report the result of these operations to the remote equipment DSRV by means of numerous notifications similar to the notifications Ntf(Di) (for i=1 to N) that are represented here.

The sending of a notification Ntf(Di) will generally take place spontaneously, i.e. at the initiative of the concerned local equipment itself. However, in the mode of implementation of the invention described here, the remote equipment DSRV is capable of sending read access requests Req(IdD, IdEq) for accessing any piece of data D identified by an identifier IdD which is the object of a processing within a local equipment identified by an identifier IdEq. Such requests could be sent automatically and periodically according to a technique known to those skilled in the art as “polling”, but requests of this kind could also be sent out non-automatically and aperiodically, for example upon a command from a tele-operator who would carry out a reading of data during a remote troubleshooting or maintenance procedure.

Any read access request Req(IdD, IdEq) sent by the remote equipment DSRV is then routed by the network NTW to the local equipment STBi corresponding to the identifier IdEq, to which said request arrives in the form of a signal Req(Di).

In the example of implementation illustrated by the present figure, the communications system SYST furthermore includes a plurality of home gateways HGW1 . . . HGWK, each one herein carrying out the management of a wireless local network. Thus, the home gateway HGW1 is connected via Wi-Fi, CPL or other types of links to local equipments UE11, UE12 and UE13, constituted in this example by a set-top box, a DECT type telephone and a personal computer. The home gateway HGWK is connected via Wi-Fi, CPL or other types of links to local equipments UEK1, UEK2, UEK3 and UEK4, constituted respectively in this example by a set-top box, a communicating tablet, a DECT type telephone and a personal computer. In this configuration, the home gateways HGW1 . . . HGWK are equipments distinct from the local equipments UE1j (for j=1 to 3) . . . UEKm (for m=1 to 4) and can be considered to be remote equipments relative to said local equipments while they are themselves considered to be local equipments relative to the remote equipment DSRV. In other words, the home gateways HGW1 . . . HGWK are first-level remote equipments relative to the local equipments UE1j (for j=1 to 3) . . . UEKm (for m=1 to 4), the equipment DSRV being a second-level remote equipment relative to the local equipments UE1j (for j=1 to 3) . . . UEKm (for m=1 to 4).

In a manner similar to the mode of operation described further above, the home gateways HGW1 . . . HGWK are intended for the sending, to said remote equipment DSRV, of notifications Ntf(D1j) . . . Ntf(DKm) which, in the embodiment described in FIG. 1, are generated by local equipments UE1j (for j=1 to 3)) . . . UEKm (for m=1 to 4) when steps for processing primitive parameters D1j . . . DKm executed within local equipments will produce results according to predetermined criteria.

In addition, when the remote equipment DSRV sends a read access request Req(IdD, IdEq) for accessing a value of a primitive value D1j . . . DKm followed by one of the local equipments UE1j (for j=1 to 3)) . . . UEKm (for m=1 to 4), this request is routed by the network NTW to that one of the home gateways HGW1 . . . HGWK which manages the local equipment concerned and is transmitted by said home gateway to the local equipment corresponding to the identifier IdEq in the form of a signal Req(D1j) . . . Req(DKm).

### 3. Description of a Variant of Implementation

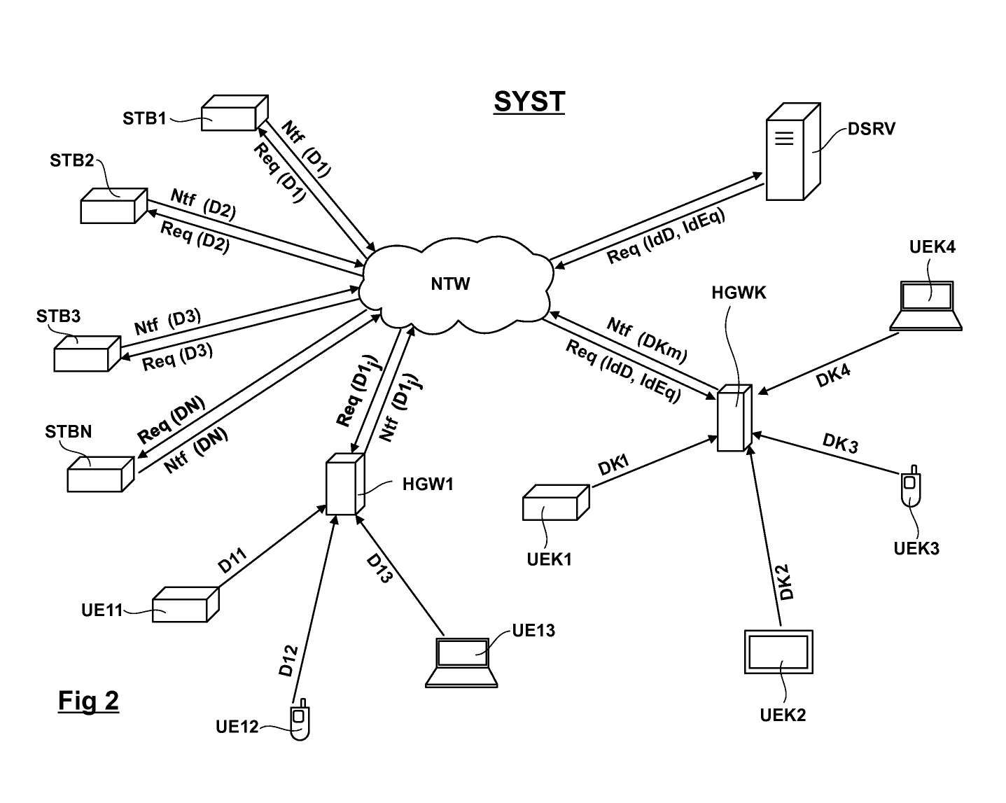

FIG. 2 illustrates an alternative of implementation in which the local networks managed by the home gateways HGW1 . . . HGWK have sufficient bandwidth available to authorize a large volume of communication of data. According to this variant, it is not necessary for the local equipments UE1j (for j=1 to 3) . . . UEKm (for m=1 to 4) to integrate both means for measuring primitive parameters and means for processing said parameters, since the substantial bandwidth available permits systematic transmission to the home gateways, and without preliminary processing by local equipments, of the values of parameters D1j . . . DKm measured by said equipments. In such a local-area network, the processing is then done in a centralized manner by the gateway which includes, to this end, processing means of which the local equipments can therefore be relieved.

In such a configuration, when the remote equipment DSRV sends a read access request Req(IdD, IdEq) for accessing a primitive parameter D1j . . . DKm tracked by one of the local equipments UE1j (for j=1 to 3)) . . . UEKm (for m=1 to 4), this request is routed by the network NTW towards that one of the home gateways HGW1 . . . HGWK which manages the local equipment concerned and is forwarded to said home gateway in the form of a signal Req(D1j) . . . Req(DKm), this request not having to be then transferred by said gateway to the local equipment concerned since the home gateway already contains all the values measured by the local equipments managed by this gateway.

### 4. Description of One Embodiment

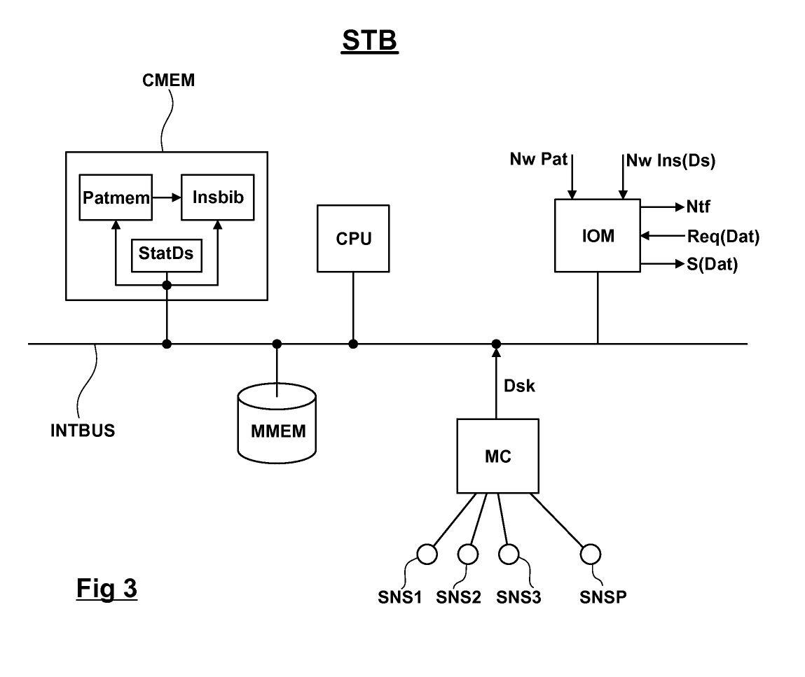

FIG. 3 represents a possible embodiment of the processing means included in a local equipment STB similar to those referred to here above. In this example of an embodiment, the processing means include a microprocessor-based central processing unit CPU and a cache memory CMEM, and are intended for communicating via a bus INTBUS with a microcontroller C, a mass memory MMEM, and input/output means IOM.

The microcontroller MC is connected to a multiplicity of sensors SNS1, SNS2, SNS3 . . . SNSP, each one of which is capable of measuring a value Dsk (for k=1 to P) of a primitive parameter representing conditions of operation of the equipment STB, for example a date, an operating temperature, a supply voltage or current etc. The microcontroller MC is thus capable of rendering, in real time, a multiplicity of values Dsk adopted by said primitive parameters, these values being transmitted via the bus INTBUS to the cache memory MMEM to be stored therein in the course of time.

In operating configuration, instructions defining computation functions having at least one primitive as a variable are stored in the cache memory CMEM in a library of instructions Insbib in order to be executed by the central processing unit CPU. In the course of executing these instructions, the central processing unit CPU extracts, as operands, the values Dsk of the relevant primitive parameters stored in the mass memory MMEM and stores the result of the computations in a directory StatDs. When each result of a computation function is itself the object of a computation, defined by at least one instruction included in the library of instructions Insbib, the central processing unit CPU determines whether or not this result complies with a predetermined criterion. If the answer is yes, then the central processing unit CPU generates a notification Ntf and makes it reach the input/output means TOM via the bus INTBUS so that said notification Ntf is sent to the remote equipment.

Besides, the input/output means TOM are also capable of receiving read access requests Req(Dat) from the remote equipment for accessing the values Dsk and/or the data contained in the directory StatDs, and of sending the remote equipment data signals S(Dat) representing data to which read access has been requested by said remote equipment.

The instructions library Insbib included in the processing means represented here comprises an essential core of basic computing functions such as the elementary mathematical and logic operations, so that these processing means are capable of processing numbers, strings of characters and Boolean values. Provided with this essential core, the computation unit will also be capable of performing elementary statistical computations such as determining minimum, maximum and average values, etc.

The processing means represented here are furthermore dynamically configurable by software means in order to enable the local equipment STB to perform any type of computation that could produce a piece of information of interest to the remote equipment.

Thus, the processing means are capable of incorporating, within said library of instructions Insbib, via the input/output means IOM, new computation functions having at least one primitive parameter as a variable.

These computation functions could be defined one by one, using novel instructions NwIns(Ds), which could for example be downloaded by the local equipment STB upon a command from the remote equipment, but they could at times be generated automatically or semi-automatically. Thus, according to one particular embodiment of the invention, the local equipment STB could download and store, in a directory of models Patmem, a model NwPat for breaking down one or more parameters. This model, when applied to one of more given parameters, will enable an automatic breakdown of said parameter or parameters into a series of predetermined functions having this parameter or these parameters as a variable.

In this embodiment, it will then be enough to enter a parameter in relation to a breakdown model included in the directory of models Patmem to generate a family of functions relative to this parameter. A breakdown model applied to a given parameter could for example include a function “Min” giving the minimum value attained by this parameter, a function <<MinTime>> giving the date and time at which this minimum value has been attained, a function <<Max>> giving the minimal value attained by this parameter and a function <<MaxTime>> giving the date and the time at which this maximum value has been attained. Thus, starting from only one primitive parameter, four values representing conditions of operation of the local equipment will be automatically generated.

The invention thus offers great flexibility of use since it enables computation of any physical quantity whatsoever from the values of the primitive parameters. It is therefore no longer necessary to predefine and physically implement complex functions in large numbers as in the prior art since the processing means are capable of being programmed dynamically to carry out any type of computation.

An exemplary embodiment of the disclosure relates to a method and equipment in which it is not necessary to implement, in advance, a large number of functions of computation of values representing conditions of operation of said equipment.

Although the present disclosure has been described with reference to one or more examples, workers skilled in the art will recognize that changes may be made in form and detail without departing from the scope of the disclosure and/or the appended claims.

1. A method for communicating information to remote equipment on conditions of operation of local equipment, wherein the method includes:
a step of measuring at least one value of a primitive parameter representing said conditions of operation, and
a step of processing said parameter by means a computation unit capable of executing a plurality of computation operations.

2. The method for communicating according to claim 1, wherein the method includes a step of transmitting, to said remote equipment, a notification generated when the processing step produces a result according to a pre-determined criterion.

3. The method for communicating according to claim 1, wherein the method further includes at least one step of software configuration of the computation unit by incorporation, within said plurality of computation operations, of at least one computation function having at least one primitive parameter as a variable.

4. The method for communicating according to claim 3, wherein the method further includes at least one step of entering a parameter and one step of automatically breaking down said parameter into a series of predetermined functions having this parameter as a variable.

5. Local equipment capable of communicating information, to remote equipment, on operating conditions of said local equipment, wherein the local equipment includes:
means for measuring at least one value of a primitive parameter representing said conditions of operation, and
means for processing said parameter comprising a computation unit capable of executing a plurality of operations of computation.

6. A system of communication including at least one local equipment according to claim 5 and a remote server configured to receive information on the conditions of operation of said local equipment.

7. A hardware computer-readable memory comprising a computer program stored thereon and comprising program code instructions for implementing a method for communicating information to remote equipment on conditions of operation of local equipment, when this program is executed by a processor, wherein the method includes:
a step of measuring at least one value of a primitive parameter representing said conditions of operation, and
a step of processing said parameter by a computation unit capable of executing a plurality of computation operations.
